(19) United States
(12) Patent Application Publication
(10) Pub. No.: US 2009/0242526 A1
(43) Pub. Date: Oct. 1, 2009

(54) LASER MICROMACHINING THROUGH A PROTECTIVE MEMBER

(75) Inventor: Leo Baldwin, Portland, OR (US)

Correspondence Address: ELECTRO SCIENTIFIC INDUSTRIES/STOEL RIVES, LLP, 900 SW FIFTH AVE., SUITE 2600, PORTLAND, OR, 97204-1268, US

(73) Assignee: Electro Scientific Industries, Inc., Portland, OR (US)

(21) Appl. No.: 12/056,154

(22) Filed: Mar. 26, 2008

(51) Int. Cl. B23K 26/38

(52) U.S. Cl. 219/121.69; 219/121.67

(57) ABSTRACT

A small feature at a target location on a working surface of a workpiece is laser machined. A laser beam propagating along a beam path is directed for incidence at the target location on the working surface to machine the small feature. A focusing lens sized to converge the laser beam on the working surface is set in the beam path at a short working distance from the working surface to laser machine the small feature and thereby eject target material from the workpiece back toward the focusing lens. A sacrificial protective member positioned between the focusing lens and the working surface transmits without appreciable distortion or adsorption the laser beam focused by the focusing lens and incident on the working surface. The sacrificial protective member intercepts the ejected target material to prevent a sufficient amount of it from reaching and thereby appreciably contaminating the focusing lens.

### TECHNICAL FIELD

This disclosure describes a laser micromachining system that includes a lens and a sacrificial protective member to prevent appreciable contamination of the lens.

### BACKGROUND INFORMATION

A conventional laser micromachining system includes a lens to focus a laser beam at a target location on a working surface of a workpiece. The focused laser beam removes material from the workpiece and produces ejected target material that is spewed in a direction towards the lens. A conventional system positions the lens at a working distance sufficiently far from the workpiece (for example, 50 millimeters (mm)) so that no portion of the ejected target material contacts and contaminates the lens.

In the field of laser micromachining, however, small machined features on the workpiece are desired. Small machined features require a lens with a high numerical aperture (NA)—for example, a NA of 1—to create a small diffraction-limited spot incident on the working surface of the workpiece. Because the lenses of conventional laser micromachining systems are positioned at a far working distance to prevent the ejected target materials from reaching the lens, conventional systems use focusing lenses with large diameters to achieve high NA. For example, a lens with a diameter of 100 mm, positioned at a working distance of 50 mm, is traditionally used to achieve a NA of 1. Lenses with large diameters lead to high costs.

Therefore, a need exists for a laser micromachining system that includes a high NA lens that is smaller, cheaper, and positioned at a closer working distance—without the lens becoming contaminated by ejected target material—than a lens of a conventional laser micromachining system.

### SUMMARY OF THE DISCLOSURE

The preferred embodiments disclosed perform laser machining of a small feature at a target location on a working surface of a workpiece. A laser beam propagating along a beam path is directed for incidence at the target location on the working surface of the workpiece to machine the small feature. A focusing lens sized to converge the laser beam on the working surface is set in the beam path and at a short working distance from the working surface to laser machine the small feature and thereby eject target material from the workpiece back toward the focusing lens. A sacrificial protective member positioned between the focusing lens and the working surface of the workpiece transmits without appreciable distortion or adsorption the laser beam focused by the focusing lens and incident on the working surface. The sacrificial protective member intercepts the ejected target material to prevent a sufficient amount of it from reaching and thereby appreciably contaminating the focusing lens.

This approach allows a focusing lens to be set at a short working distance from a working surface of a workpiece without becoming appreciably contaminated by ejected target material. Because the focusing lens can be set at a short working distance, the focusing lens may have a small diameter, and be characterized by a high NA and high performance (i.e., small spot size).

Additional aspects and advantages will be apparent from the following detailed description of preferred embodiments, which proceeds with reference to the accompanying drawings.

### BRIEF DESCRIPTION OF THE DRAWINGS

FIG. 1 is a simplified diagram of a laser micromachining system of a preferred embodiment.

FIGS. 2a and 2b depict a flexible sheet of the laser micromachining system according to a first embodiment.

FIGS. 3a and 3b depict a rigid sheet of the laser micromachining system according to a second embodiment.

FIG. 4 depicts a conformal layer of the laser micromachining system according to a third embodiment.

FIGS. 5a and 5b show the comparative relationship between, respectively, the laser micromachining system of the preferred embodiments and a conventional laser micromachining system.

FIG. 6 depicts multiple laser beams and multiple associated lenses used in the laser micromachining system of the preferred embodiments.

### DETAILED DESCRIPTION OF PREFERRED EMBODIMENTS

Preferred embodiments of a laser micromachining system are described below. System components with like reference numerals perform the same functions in each of the embodiments described. The preferred embodiments of the laser micromachining system include one or more lenses that are positioned at a sufficiently short working distance from a working surface of a workpiece without the lens or lenses becoming appreciably contaminated by ejected target material of the workpiece.

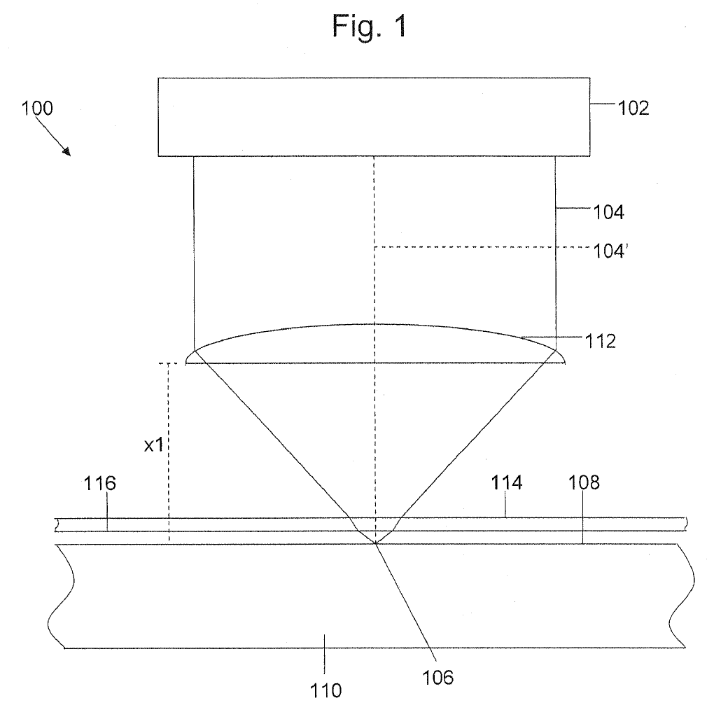

FIG. 1 depicts a laser micromachining system 100 that includes a laser beam source 102. Laser beam source 102 generates and emits a laser beam 104 that propagates along a beam path, represented by a beam axis 104′, for incidence at a target location 106 on a working surface 108 of a workpiece 110. Laser beam source 102 may be any type of laser energy generating device known to skilled persons. Laser micromachining system 100 may also include mirrors (not shown) to change the beam path of laser beam 104 (i.e., laser beam source 102 may be at a position other than directly above target location 106). Laser micromachining system 100 includes a lens 112 positioned in the beam path of laser beam 104 to focus laser beam 104 at target location 106. Lens 112 converges laser beam 104 on working surface 108 to laser machine small features that include, for example, feature dimensions ranging between about 0.25 micrometers (μm) and about 50 μm.

Lens 112 may be any type of converging lens capable of focusing laser beam 104 at target location 106. A diameter of lens 112 may be any size, but, preferably, lens 112 is a small lens having a diameter of less than 100 mm. The diameter of lens 112 is determined by a working distance x1 between lens 112 and working surface 108 and a desired NA. For example, if a NA of 1 is desired and working distance x1 between lens 112 and working surface 108 is approximately 25 mm, the diameter of lens 112 can be approximately 50 mm. If working distance x1 between lens 112 and working surface 108 is approximately 5 mm, the diameter of lens 112 can be approximately 10 mm to achieve a NA of 1. For a given NA and a given performance (i.e., spot size at target location 106) the diameter of lens 112 varies directly in relation to a change in working distance x1. The mass of lens 112 scales as the third power of the diameter and hence the third power of working distance x1. Lens 112 may be one of multiple lenses in a compound lens system. Lens 112 may be a lens designed to operate in conjunction with a protective layer. For example, lens 112 may be a lens of a type used in compact disk (CD) and digital versatile disk (DVD) technology that is designed to operate through a protective layer provided on the CD or DVD.

Laser micromachining system 100 includes a sacrificial protective member 114 positioned between lens 112 and working surface 108 of workpiece 110. Sacrificial protective member 114 is spaced apart from working surface 108 in the embodiment shown. Sacrificial protective member 114 transmits laser beam 104 focused by lens 112 for incidence on working surface 108 at target location 106 without appreciably distorting and adsorbing laser beam 104. Sacrificial protective member 114 may have an optical impact on laser beam 114, but when designing lens 112 and other optical components of laser micromachining system 100, the optical impact of sacrificial protective member 114 may be compensated for (i.e., lens 112 may be fully corrected when used with sacrificial protective member 114).

In operation, as laser beam 104 is incident on working surface 108 at target location 106, laser beam 104 removes target material from target location 106 and produces ejected target material that spews in a direction away from working surface 108 and generally along the beam path. The ejected target material spewed in a direction along the beam path means that at least some of the ejected target material spews generally in a direction toward lens 112 such that unimpeded ejected target material would contact and contaminate lens 112. Sacrificial protective member 114 intercepts the ejected target material to prevent the ejected target material from reaching and appreciably contaminating lens 112. Sacrificial protective member 114 is sacrificial in that it is used once per workpiece because after laser beam 104 produces the ejected target material, a surface 116 of sacrificial protective member 114 includes embedded ejected target material that may make sacrificial protective member 114 optically unsuitable for use with subsequent workpieces (i.e., sacrificial protective member 114 becomes unusable to transmit laser beam 104 focused by lens 112 at target location 106). Sacrificial protective member 114 will now be described in more detail according to the following embodiments.

### First Embodiment

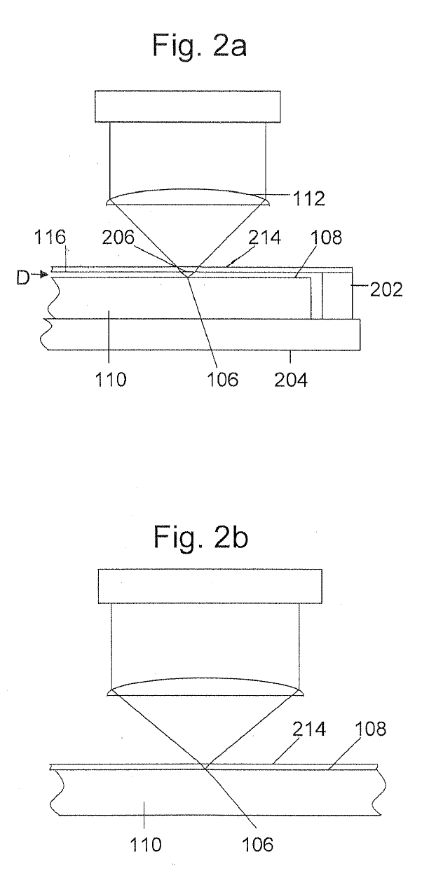

According to a first embodiment depicted in FIGS. 2a and 2b, sacrificial protective member 114 is a flexible sheet 214. Flexible sheet 214 can be any type of transparent material capable of transmitting laser beam 104 without appreciable distortion or adsorption. For example, depending on the wavelength and fluence of laser beam 104, polymers such as polycarbonate, polymethylmethacrylate (PMMA), polystyrene (PS), polyvinylidene chloride (PVDC), optical grade polyurethane (PU), cyclic olefin polymer/copolymer (COP/COC), polyethylene terephthalate (PET) and polyetheramide (PEI) would all be good candidates for flexible sheet 214. For example, all of these materials are transparent in the visible and near infrared but only certain grades of PMMA are transparent to 350 nanometers (nm), making PMMA the preferred choice for a 355 nm laser. All are relatively inexpensive and are available in thin sheets. PMMA, PS, and olefins have high internal transmittance, making them preferred candidates for high fluence beams where adsorption of laser energy could lead to destruction of flexible sheet 214 before it fulfills its purpose.

With reference to FIG. 2a, flexible sheet 214 is suspended above working surface 108 (i.e., flexible sheet 214 does not contact working surface 108) by a frame 202. Frame 202 also holds flexible sheet 214 taut. Frame 202 may be held in place by, or connected to, a chuck 204 that also holds workpiece 110. Flexible sheet 214 may have a surface area that is larger than a surface area of working surface 108. Because flexible sheet 214 is suspended above working surface 108, flexible sheet 214 may accommodate a large amount of ejected target material. The ejected target material may be spread out over a large area on surface 116 by having a relatively large gap distance D between flexible sheet 214 and working surface 108. Or, gap distance D between flexible sheet 214 and working surface 108 can be made relatively small so that the ejected target material is embedded in a localized location 206 on surface 116 corresponding to target location 106 to prevent the embedded ejected target material from interfering with removal of other target material at other target locations.

Alternatively, flexible sheet 214 may contact working surface 108 of workpiece 110. With reference to FIG. 2b, flexible sheet 214 is laid on and clings to working surface 108 of workpiece 110. Because flexible sheet 214 clings to working surface 108, the ejection of some target material may be physically impeded and remain on working surface 108 near target location 106. Therefore, having flexible sheet 214 cling to working surface 108 may be best suited for situations in which a relatively small amount of material is removed. In either situation—suspended above or contacting—flexible sheet 214 is easily removable after workpiece 110 has been processed.

### Second Embodiment

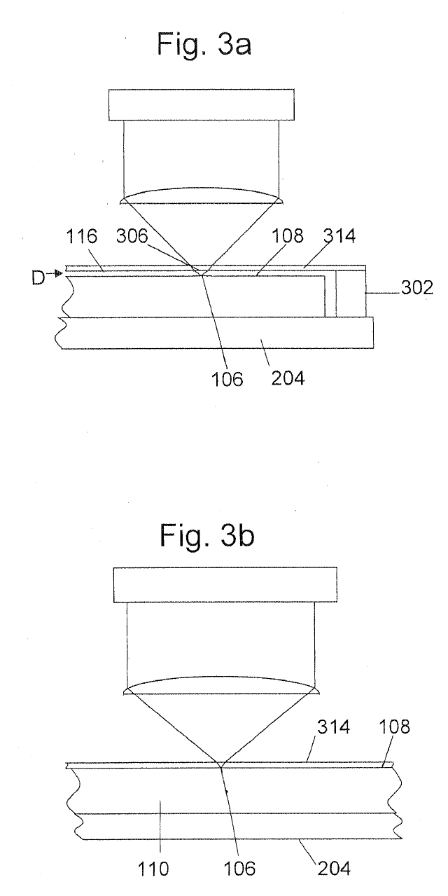

According to a second embodiment depicted in FIGS. 3a and 3b, sacrificial protective member 114 is a rigid sheet 314. Rigid sheet 314 can be any type of transparent material capable of transmitting laser beam 104 without appreciable distortion or adsorption. For example, depending on the wavelength and fluence of laser beam 104, glass or fused silica or polymers such as polycarbonate, polymethylmethacrylate (PMMA), polystyrene (PS), polyvinylidene chloride (PVDC), optical grade polyurethane (PU), cyclic olefin polymer/copolymer (COP/COC), polyethylene terephthalate (PET) and polyetheramide (PEI) would all be good candidates for rigid sheet 314. For example, all of these materials are transparent in the visible and near infrared but only fused silica and certain grades of PMMA are transparent to 350 nanometers (nm), making fused silica or PMMA the preferred choice for a 355 nm laser. All are relatively inexpensive and are available in thick sheet form or can be injection molded to the desired shape and thickness. Fused silica, glass, PMMA, PS, and olefins have high internal transmittance, making them preferred candidates for high fluence beams where adsorption of laser energy could lead to destruction of rigid sheet 314 before it fulfills its purpose.

With reference to FIG. 3a, rigid sheet 314 is suspended above working surface 108. Rigid sheet 314 may be suspended above working surface 108 by a sheet support 302. Sheet support 302 may be connected to chuck 204 or may be a unified part of chuck 204. Also, rigid sheet 314 may be suspended above working surface 108, supported on a lip outside working surface 108, and held down to chuck 204 by vacuum pressure or by a mechanical fixture. Typically, rigid sheet 314 has a surface area larger than that of working surface 108. Because rigid sheet 314 is suspended above working surface 108, rigid sheet 314 may accommodate a large amount of ejected target material. The ejected target material may be spread out over a large area on surface 116 by having a relatively large gap distance D between rigid sheet 314 and working surface 108. Or, gap distance D between rigid sheet 314 and working surface 108 can be made relatively small so that the ejected target material is embedded in a localized location 306 on surface 116 corresponding to target location 106 to prevent the embedded ejected target material from interfering with removal of other target material at other target locations.

Alternatively, rigid sheet 314 may contact working surface 108 of workpiece 110. With reference to FIG. 3b, rigid sheet 314 is laid on working surface 108 of workpiece 110. Rigid sheet 314 is held down against chuck 204 by vacuum pressure or by a mechanical fixture. Because rigid sheet 314 contacts working surface 108, the ejection of some target material may be physically impeded and remain on working surface 108 near target location 106. Therefore, having rigid sheet 314 contact working surface 108 may be best suited for situations in which a relatively small amount of material is removed. In either situation—suspended above or contacting—rigid sheet 314 is easily removeable after workpiece 110 has been processed.

### Third Embodiment

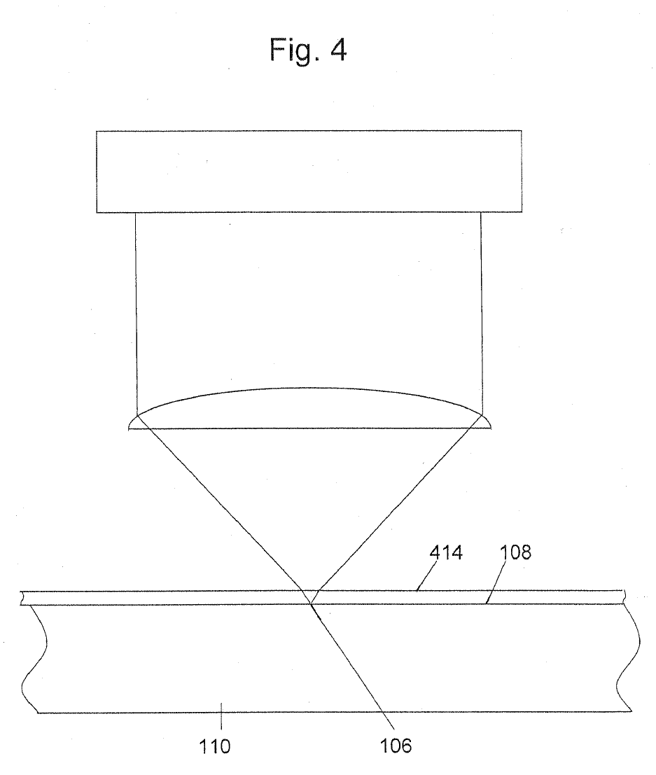

According to a third embodiment depicted in FIG. 4, sacrificial protective member 114 is a conformal coating 414 on working surface 108 of workpiece 110. Conformal coating 414 may be deposited on working surface 108 by an evaporation coating process (i.e., parylene coating) or a spin coating process. Conformal coating 414 may be a polymer material similar to the materials used for flexible sheet 214 and rigid sheet 314 dissolved in a carrier or applied in a two-part process where polymerization takes place on workpiece 110. After removal of target material, conformal coating 414 may be removed or left on working surface 108. Conformal coating 414 may be desired when small amounts of material are removed because (i) conformal coating 414 may not sequester all ejected target material, (ii) conformal coating 414 may physically impede ejection of the target material leaving some target material in target location 106, and (iii) the optical properties of conformal coating 414 may degrade during the removal process on a single feature, interfering with latter removal stages.

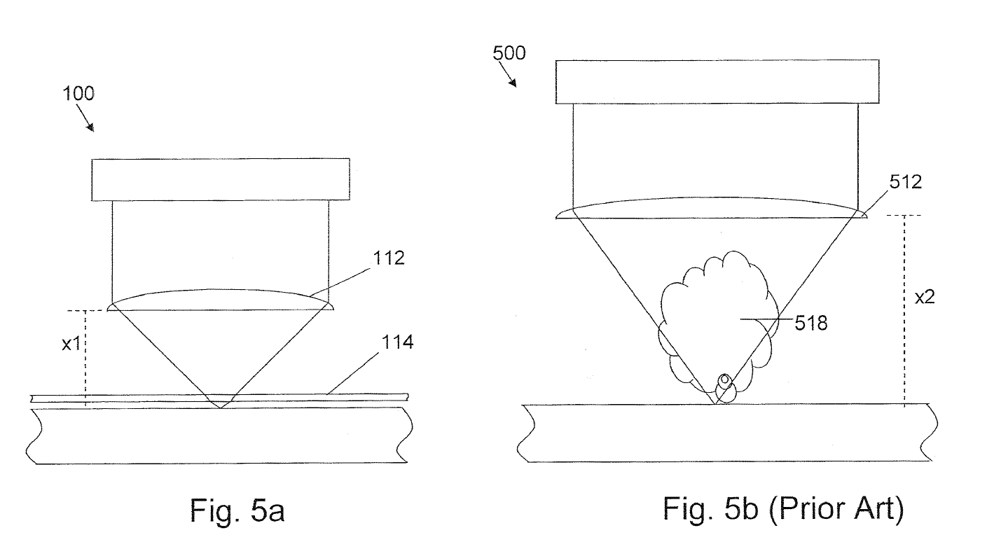

The embodiments described above present numerous advantages compared to conventional laser micromachining systems. FIGS. 5a and 5b (not to scale) show a comparison of, respectively, laser micromachining system 100 of the preferred embodiments and a conventional laser micromachining system 500. For example, because sacrificial protective member 114 of laser micromachining system 100 intercepts ejected target material spewing towards lens 112, lens 112 can be positioned at a working distance x1 that is shorter than a working distance x2 of conventional laser micromachining system 500 (i.e., if working distances x1 and x2 were equal, ejected target material 518 would contaminate a lens 512 of conventional laser micromachining system 500). In other words, working distance x1 can be sufficiently short such that, if spewed ejected target material were unimpeded, it would reach lens 112.

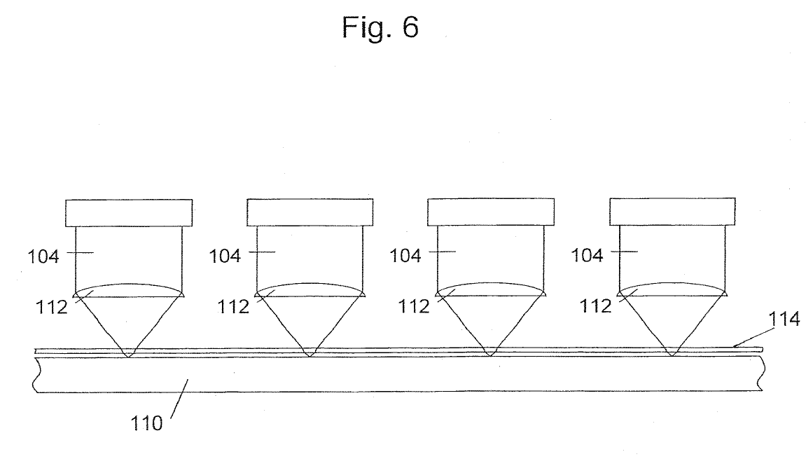

Also, because lens 112 can be positioned at a close working distance, lens 112 can be smaller than lens 512 of conventional laser micromachining system 500 while still achieving a high NA and high performance. As a smaller lens, lens 112 can be less expensive than lens 512. Lens 112 can also be lighter in weight than lens 512 so that dynamics of a lens focusing mechanism of laser micromachining system 100 can be improved. Also, because lens 112 is smaller than lens 512, multiple lenses 112 and laser beams 104 may be provided operating in parallel on workpiece 110, as depicted in FIG. 6.

It will be obvious to those having skill in the art that many changes may be made to the details of the above-described embodiments without departing from the underlying principles of the invention. The scope of the present invention should, therefore, be determined only by the following claims.

1. A method of configuring a laser micromachining system for laser machining a small feature at a target location on a working surface of a workpiece, comprising:
directing a laser beam propagating along a beam path for incidence at a target location on a working surface of a workpiece to machine a small feature of the workpiece;
setting in the beam path and at a short distance from the working surface a focusing lens sized to converge the laser beam on the working surface to laser machine the small feature and thereby eject target material from the workpiece back toward the focusing lens; and
positioning a sacrificial protective member between the focusing lens and the working surface of the workpiece, the sacrificial protective member transmitting without appreciable distortion and adsorption the laser beam focused by the focusing lens and incident on the working surface, and the sacrificial protective member intercepting the ejected target material to prevent a sufficient amount of it from reaching and thereby appreciably contaminating the focusing lens.

2. The method of claim 1, further comprising setting the focusing lens at a distance less than 50 mm from the working surface of the workpiece.

3. The method of claim 1, further comprising suspending the sacrificial protective member above the working surface of the workpiece so that the sacrificial protective member does not contact the working surface.

4. The method of claim 1, further comprising laying the sacrificial protective member on top of and in contact with the working surface of the workpiece.

5. A laser micromachining system that removes target material from a workpiece, comprising:
a laser beam source emitting a laser beam that propagates along a beam path for incidence at a target location on a working surface of a workpiece, the laser beam removing target material from the workpiece at the target location and thereby producing ejected target material spewing in a direction away from the working surface;
a lens positioned in the beam path to focus the laser beam at the target location on the working surface of the workpiece, the lens set at a working distance from the working surface of the workpiece, the working distance being sufficiently short to permit unimpeded spewed ejected target material to reach the lens; and
a sacrificial protective member positioned between the lens and the working surface of the workpiece, the sacrificial protective member transmitting without appreciable distortion and adsorption the laser beam focused by the lens and incident on the working surface, and the sacrificial protective member intercepting the ejected target material to prevent a sufficient amount of it from reaching and thereby appreciably contaminating the lens.

6. The laser micromachining system of claim 5, in which the intercepted ejected target material is embedded in the sacrificial protective member and renders the sacrificial protective member unusable to transmit the laser beam focused by the lens at the target location.

7. The laser micromachining system of claim 5, in which the working distance is less than 50 millimeters.

8. The laser micromachining system of claim 5, in which the sacrificial protective member is a conformal coating deposited on the working surface of the workpiece.

9. The laser micromachining system of claim 8, in which the conformal coating is an evaporation coating.

10. The laser micromachining system of claim 8, in which the conformal coating is a spin coating.

11. The laser micromachining system of claim 5, in which the sacrificial protective member is a rigid sheet.

12. The laser micromachining system of claim 11, in which the workpiece is held in place by a chuck, and the rigid sheet contacts the working surface and is held down against the working surface by the chuck.

13. The laser micromachining system of claim 11, in which the workpiece is held in place by a chuck, and the rigid sheet is suspended above the working surface by a sheet support connected to the chuck.

14. The laser micromachining system of claim 5, in which the sacrificial protective member is a flexible sheet.

15. The laser micromachining system of claim 14, in which the flexible sheet contacts and clings to the working surface.

16. The laser micromachining system of claim 14, in which the workpiece is held in place by a chuck, and the flexible sheet is suspended above the working surface and is held taut by a frame connected to the chuck.

17. The laser micromachining system of claim 5, in which the lens is one of multiple lenses that focuses one of multiple laser beams at one of multiple target locations on the working surface, and the sacrificial protective member transmits the multiple laser beams for incidence at the multiple target locations.

18. The laser micromachining system of claim 5, in which sacrificial protective member optically impacts the laser beam and the lens is positioned to account for the optical impact of the sacrificial protective member so that the lens focuses the laser beam at the target location.
